(19) United States
(12) Patent Application Publication
(10) Pub. No.: US 2018/0239851 A1
(43) Pub. Date: Aug. 23, 2018

(54) APPARATUS AND METHOD FOR INFERRING PARAMETERS OF A MODEL OF A MEASUREMENT STRUCTURE FOR A PATTERNING PROCESS

(71) Applicant: ASML NETHERLANDS B.V., Veldhoven (NL)

(72) Inventors: Alexander YPMA, Veldhoven (NL); Maurits VAN DER SCHAAR, Eindhoven (NL); Georgios TSIROGIANNIS, Eindhoven (NL); Leendert Jan KARSSEMEIJER, Utrech (NL); Chi-Hsiang FAN, San Jose,, CA (US)

(73) Assignee: ASML NETHERLANDS B.V., Veldhoven (NL)

(21) Appl. No.: 15/900,735

(22) Filed: Feb. 20, 2018

Related U.S. Application Data
(60) Provisional application No. 62/461,654, filed on Feb. 21, 2017.

(51) Int. Cl. G06F 17/50; G06N 7/00

(52) U.S. Cl. CPC G06F 17/5009; G06N 7/005

(57) ABSTRACT

A process of calibrating parameters of a stack model used to simulate the performance of measurement structures in a patterning process, the process including: obtaining a stack model used in a simulation of performance of measurement structures; obtaining calibration data indicative of performance of the measurement structures; calibrating parameters of the model by, until a termination condition occurs, repeatedly: simulating performance of the measurement structures with the simulation using a candidate model; approximating the simulation, based on a result of the simulation, with a surrogate function; and selecting a new candidate model based on the approximation.

This application claims the benefit of priority of U.S. Provisional Patent Application No. 62/461,654, filed Feb. 21, 2017, which is incorporated by reference herein in its entirety.

### FIELD

The present description relates generally to patterning processes and, more specifically, to inferring parameters of a model of a measurement structure for a patterning process.

### BACKGROUND

Patterning processes take many forms. Examples include photolithography, electron-beam lithography, imprint lithography, inkjet printing, directed self-assembly, and the like. Often these processes are used to manufacture relatively small, highly-detailed components, such as electrical components (like integrated circuits or photovoltaic cells), optical components (like digital mirror devices or waveguides), and/or mechanical components (like accelerometers or microfluidic devices).

Often, patterning processes are monitored or controlled based on measurement structures formed on the substrate receiving the pattern. Monitoring often includes ex situ measurements of the measurement structures performed after a pattern is applied. This is done, in many cases, in order to determine whether the process is yielding products within specified tolerances, to detect process drift, and/or to provide feedback for adjusting the process. In some cases, the measurement structures take the form of overlay metrology targets to measure a resulting amount of misalignment after a pattern is applied. In some cases, in situ measurements are performed on the measurement structures to control the process, for instance, to align equipment to pre-existing patterns on the substrate before applying subsequent patterns. In some cases, the measurement structures take the form of alignment marks used by a lithographic apparatus or other patterning equipment to align the equipment to the substrate before a pattern is applied.

### SUMMARY

The following is a non-exhaustive listing of some aspects of the present techniques. These and other aspects are described in the following disclosure.

Some aspects include a process of calibrating parameters of a model used to simulate the performance of alignment marks, overlay metrology targets, or other measurement structures in patterning processes, the process including: obtaining, with one or more processors, a model used in a simulation of performance of measurement structures used in a patterning process; obtaining, with one or more processors, empirical measurements of performance of the measurement structures in the patterning process; and after obtaining the empirical measurements, with one or more processors, calibrating parameters of the model by, until a termination condition occurs, repeatedly: simulating performance of the measurement structures with the simulation using a candidate model having candidate-model parameters; approximating the simulation over a range of candidate models, based on a result of the simulation, with a surrogate function that is faster to compute than the simulation, wherein the surrogate function: takes as an input candidate models having candidate-model parameters; and outputs both measures of fitness and measures of uncertainty about fitness, wherein fitness is indicative of differences between approximated simulation results based on input candidate models and the obtained empirical measurements; and selecting a new candidate model based on the approximation; and storing, with one or more processors, the calibrated parameters of the model in memory.

Some aspects include a tangible, non-transitory, machine-readable medium storing instructions that when executed by a data processing apparatus cause the data processing apparatus to perform operations including all or part of a process described herein.

Some aspects include a system, including: one or more processors; and memory storing instructions that when executed by the one or more processors cause the one or more processors to effectuate operations of all or part of a process described herein.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a flowchart of a process to design, use, and calibrate measurement structures in accordance with some embodiments;

FIG. 2 is a cross section of an example of a measurement structure in accordance with some embodiments;

FIG. 3 is a block diagram of an example of information flow in a calibration of a measurement structure in accordance with some embodiments;

FIG. 4 is a graph of an example of a performance indicator response to two dimensions of a model used to simulate performance of a measurement structure in accordance with some embodiments;

FIG. 5 is another graph of an example of a performance indicator response to two dimensions of a model used to simulate performance of a measurement structure in accordance with some embodiments;

FIG. 6 is a graph of an example of a performance indicator response to changes in a model used to simulate performance of a measurement structure in accordance with some embodiments;

FIG. 7 is a block diagram of an example computer system;

FIG. 8 is a schematic diagram of another lithography system;

FIG. 9 is a schematic diagram of another lithography system;

FIG. 10 is a more detailed view of the system in FIG. 8; and

FIG. 11 is a more detailed view of the source collector module of the system of FIGS. 8 and 9.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

To mitigate one or more problems described herein, the inventors had to both invent solutions and, in some cases just as importantly, recognize problems overlooked (or not yet foreseen) by others in the fields of lithography and metrology. Indeed, the inventors emphasize the difficulty of recognizing those problems that are nascent and will become much more apparent in the future should trends in the lithography industry, and industries using similar processing techniques, continue as the inventors expect. Further, because multiple problems are addressed, it should be understood that some embodiments are problem-specific, and not all embodiments address every problem with traditional systems described herein or provide every benefit described herein. That said, improvements that solve various permutations of one or more of the problems are described below.

Often, spatial dimensions measured with measurement structures are smaller than the wavelength of radiation with which measurements are taken. For example, during the measurement, a measurement structure may be illuminated with radiation having a wavelength longer than 300 nanometers, while dimensions and their tolerances targeted by measured structures are often substantially less than 100 nanometers. To achieve desired levels of accuracy, in a non-destructive fashion, with high relatively throughput, often the measurements are made with relatively sensitive optical techniques, like scatterometry measurements for overlay, position measurements of alignment marks for alignment purposes, or various other techniques in which diffraction effects from radiation impinging upon a periodically varying pattern in a measurement structure produce measurable phenomena indicative of sub-wavelength dimensions.

In many cases, these relatively intricate measurements are undesirably affected by attributes of the measurement structures other than the properties (e.g., dimensions, such as alignment or overlay) being measured. For example, process variation in underlying patterns may introduce noise into the measurements and lead to less accurate or inoperative measurements. For instance, if a given underlying film thickness happens to be on a thick-side of a distribution of process variation, or a given critical dimension or overlay misalignment happens to be an outlier in a distribution of process variation, later measurements on measurement structures overlaying these features may be subject to greater error. Often, during measurements, radiation illuminating the measurement structure interacts with underlying structures in complicated ways that can affect the measurements.

In view of this phenomenon, techniques have been developed to design measurement structures that are both relatively robust to process variations and provide relatively strong signals when subject to measurement. In many cases, those designing patterning processes, before committing to a measurement structure pattern, may model various measurement structures with measurement structure simulation software, the software configured to simulate the performance of those measurement structures. In some cases, the software calculates performance indicators of the measurement structures' performance, like sensitivity of signals associated with the measurements to changes in the measurement structure dimensions and/or geometry, sensitivity of these signals to other forms of process variation, or ratios between these values. In some cases, these simulations include the use of a Maxwell solver that accounts for effects on radiation impinging upon, passing through, and/or being reflected within various layers and other structures in the measurement structure, in some cases under varying conditions indicative of distributions of process variation being modeled. Based on simulation results, designers may adjust their measurement structures to improve performance before incurring the cost of creating new patterning devices (e.g., reticles or mask) or otherwise implementing the patterning process.

In some cases, these simulations produce results that differ from the results that occur when the patterning process is performed. For example, various measurement structures may be more sensitive to variation in underlying layers than the simulation predicts. In many cases, it may not be clear which specific combination of underlying structures contributes to the difference or which aspects of the measurement itself contribute to the difference. Often, though, the difference is attributable to some aspect of the stack model used in the simulation that is different from the structures physically formed in the manufacturing process. In some cases, these stack model parameters may be referred to as “hyperparameters” of a simulated model, and in some cases, the stack model parameters characterize both nominal dimensions/attributes and statistical distributions thereof occurring in a patterning process.

Often information about the physically formed measurement structures is difficult to obtain, as the structures tend to be relatively small and expensive to measure, and in some cases, there measurement might involve destruction of the substrate to obtain a full characterization, like with vertical scanning electron microscope (vSEM) imaging. Further, in many cases, those responsible for supporting the simulation software may not have access to actual cross-sections of the measurement structures or may not have access to an adequate sample size of cross-sections of the measurement structures.

In theory, the stack model can be calibrated to fit the observations from the manufacturing process, but many techniques for calibrating stack models used in simulations of measurement structure performance are lacking in various respects. As a result, when a measurement structure is predicted to have a certain level of performance with simulation software, and that measurement structure's performance is different when actually used in a patterning process, it can be relatively difficult to adjust the stack model to cause the simulation to agree with the empirically measured performance of the measurement structure. Challenges with various techniques for calibration include the following (none of which should be read to imply that any of these techniques are disclaimed in all embodiments):
Correlated hyper (stack-) parameters can cause issues. Cross talk between tuning parameters (e.g., manifesting from perturbation of process definition parameters) can lead to scenarios in which the multi-dimensional problem space has tuning parameters coupled linearly. As a result, a local extremum (e.g., minimum or maximum) may be stretching along a linear combination of tuning parameters, making the extremum difficult to locate.
Some optimization techniques can be prone to converging to local minima. For instance, some Newtonian method-based results depend on starting conditions and may converge to a local minimum, depending on the starting conditions and the geometry of the cost function in the problem space.
Other global optimization techniques can suffer from similar or other issues. In some cases, the optimizations require a closed form expression of the function being optimized, which may not be available for many simulations.
Some optimization techniques suffer from unrealistic solution finding, for instance where the stack tuning script does not have internal information on the boundaries of tuning parameters.
Simulations can be very time consuming and require significant computing power (as the function evaluations are expensive), which can make it difficult to search in the hyper (stack-) parameter space.

To mitigate some of these, all of these, or other issues, some embodiments may implement a Bayesian optimization using a surrogate function (referred to as “GP” in some cases below) fitted to simulation results to achieve efficient stack tuning. In some cases, the surrogate function is fitted to, and calibration is achieved based on, simulations and empirical data related to both alignment marks and overlay metrology targets, or multiple alignment marks, or multiple metrology targets, or combinations thereof.

In some cases, the efficiency gains from this stack tuning approach may be deployed to enlarge the size of the optimization. For instance, some embodiments provide for concurrent simulation of multiple marks/targets and jointly optimize/infer (at least partially overlapping) stack parameter vectors. For example, some embodiments may calibrate stack model parameters for three different sets of measurement structures used at two different patterned layers of a film stack. Calibration data relating to some of the measurement structures may be used to improve the stack model for another measurement structure, such as one used in an upper layer, which may include the stack model of lower layer measurement structures as a subset of its stack model. Similarly, in some cases, the calibrated model parameters include parameters other than stack parameters, e.g., those relating to metrology equipment configuration or design. In contrast, with traditional techniques, determining a global optimum of multiple overlapping stack models and metrology parameters is typically computationally infeasible, as each simulation for each point in the parameter space typically takes too long to effectively search the space with techniques that require substantially more simulations than the present approaches.

Some embodiments implement a Bayesian global (e.g., within a predefined search space) optimization (e.g., subject to a predefined resolution of a search of the stack model parameter space) of an expensive function (like a simulation result, such as a fitness function that aggregates differences between a simulation and empirical measurements). This is expected to make hyperparameter search with simulations relatively efficient and effective. Thus, some embodiments use measurement-structure performance simulation, given the stack parameters, as an expensive function, with no closed form description (e.g., a ‘target function’ to model): f(model parameters x; other parameters y)=overlay or alignment target simulation. Since there is often uncertainty about the stack model parameters (e.g., stack parameters) and the dimensionality relative to the number of samples may be high (as function evaluations are often expensive to compute), some embodiments approximate the target function with a surrogate function (which may be referred to as a response surface) in order to sample the space x relatively efficiently. In some cases, the sampling and search of the parameter space may be implemented as a Bayesian optimization as described in Brochu, Cora & de Freitas “A tutorial on Bayesian optimization of expensive cost function with application to active user modeling and hierarchical reinforcement learning” (arXiv:1012.2599), the contents of which are hereby incorporated in its entirety by reference. In some cases, model parameters other than those of the stack may also be calibrated, e.g., those relating to the metrology equipment and its configuration.

Some embodiments minimize the expected deviation of the function value at the next query of the search space (solution approximation point in the form of a candidate model) point x1 (candidate stack parameter setting) from the function value at the global maximum x*, x1=arg min_x INT∥f(x)−f(x*)∥d P(f).

To implement this formulation, some embodiments defining a prior over functions, inferring a posterior using Bayes' rule (leading to an updated expression for P(f) as mentioned above, and selection of the next stack parameter setting x1). To this end, some embodiments may use e.g. a Gaussian process, which is a distribution over functions, and which is specified by its mean function and covariance function.

Further, to implement the above formulation, some embodiments use the evidence of accumulated observations D_{1:n}={xi, f(xi)}, i=1:n to transform prior to posterior using a data likelihood function P(D_{1:n}|f) and Bayes' rule of inference: P(f|D_{1:n}) \propto P(D_{1:n}|f) P(f).

Some embodiments may also implement a defining of a utility function (e.g., the opposite of the risk or deviation function) and a method to optimize the expected utility with respect to the posterior over the objective function P(f|D_{1:n}), e.g., with the techniques described in Brochu et al. The resulting optimization is expected to be less troublesome than one or more of the other above-noted techniques. The expected utility function is expected to be less expensive to evaluate, in some cases rendering tractable a brute force search for an extremum of the expected utility function within the parameter space of the stack model. Furthermore, since the actual underlying target function f is unknown in some cases (e.g., in some cases, operations are performed on a sample of evaluations of the simulation at certain stack parameter settings over the parameter space for the stack model), some embodiments integrate over the candidate (surrogate) functions using the posterior P(f|D_{1:n}). Once again, this is expected to be tractable, e.g., in the case that a Gaussian Process is assumed to approximate the underlying simulation target function. The actual quality of the approximation and final result in terms of stack parameters leading to a global optimum may depend on modeling choices, convergence speed, complexity of the underlying simulation function and/or effective dataset used for the modeling.

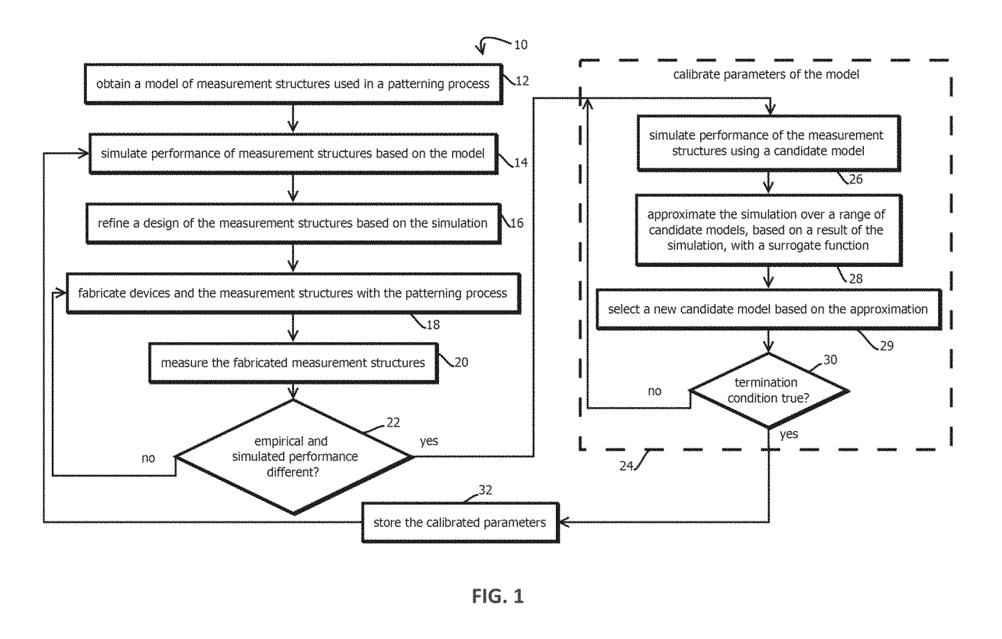

These techniques are exemplified by processes and systems described below. One or more, and in some cases all, of the above-described issues are expected to be mitigated by embodiments of various techniques described below with reference to FIGS. 1 through 6. Some embodiments may determine a global optimum (for example, approximating a global optimum within some tolerance subject to granularity of an optimization) for parameters of a stack model (or a model including both stack and metrology parameters or one or more other parameters). The optimum settings for these parameters may reduce the amount of disagreement between the simulation of the performance of a measurement structure and the observed performance of a measurement structure through empirical measurements on physically formed measurement structures obtained by a manufacturing process. Thus, some embodiments may calibrate a model of a patterned film stack in which alignment marks or overlay metrology targets are formed.

Some embodiments may perform this calibration, or other determinations described below, while reducing an amount of relatively computationally expensive and slow simulations performed on candidate stack models relative to other approaches. To this end, and others, some embodiments may calibrate the stack model with a Bayesian optimization using a surrogate function described below to approximate simulation results. In some cases, the surrogate function 1) may be substantially faster to compute than the simulation, 2) may approximate simulation results (e.g., the output from a fitness function of an aggregate measure of agreement between performance indicators of measurement structures predicted by the simulation and observed performance of the measurement structures obtained empirically through performance of the patterning process); and/or 3) may provide a measure of uncertainty regarding the approximate simulation results, e.g., indicating for each evaluated point over a parameter space of the stack model both what is known and what is unknown about the fitness of a stack model relative to the empirical data. In some cases, the surrogate function determines fitness in two stages, first by approximating performance in a first stage over the stack model parameter space, and then by determining fitness in a second stage based on differences between the surrogate function (e.g., response surface) and calibration data.

Using the surrogate function, embodiments may strategically select where in the parameter space of the model to undertake computationally-expensive full simulations. Embodiments may iteratively 1) approximate the simulation, 2) select a candidate model based on where in the parameter space the approximation indicates that it is likely to be fruitful to search according to both the uncertainty and the approximated result; 3) run the full simulation with the candidate model; and 4) update the surrogate function based on the results of the simulation of the candidate model. As a result, the surrogate function may be trained with simulations in areas of the parameter space of the model expected to correspond to the global optimum for the parameters of the model, while drawing upon relatively few simulations, as uncertainty in the approximation may be disregarded in areas of the parameter space less likely to yield a global optimum, and mitigating the risk of converging upon a local extremum, as areas of uncertainty may draw the search of the parameter space away from the local extremum in a calibration.

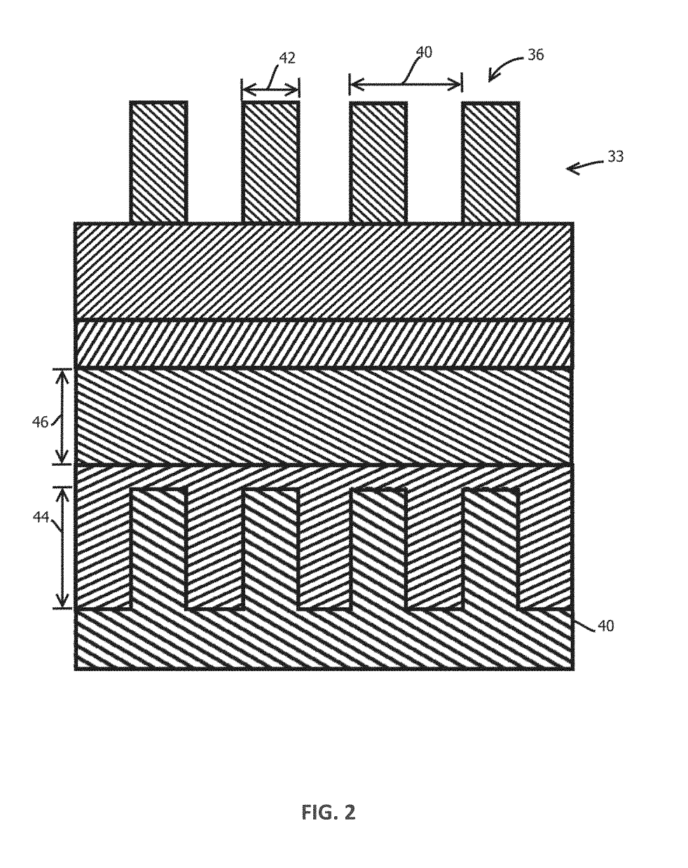

Some embodiments may implement these techniques with the process 10 shown in FIG. 1. Some embodiments include obtaining a model of measurement structures used in (e.g., to monitor or control) a patterning process, as indicated by block 12, such as a stack model. Examples of patterning processes are described below. In some cases, the measurement structures include a plurality of layers in a film stack and various overlaid gratings like those described below with reference to FIG. 2. The term “measurement structures” plural is used generically to refer to a single measurement site on a substrate, the distribution of attributes of the measurement structure across a plurality of samples, or both. Examples of parameters in the stack model are described in greater detail and include things like one or more critical dimensions, one or more film thicknesses, one or more etch depths, one or more sidewall profiles, and/or a statistical distribution thereof. For instance, a given stack model may include a first layer with a Gaussian distribution, a mean thickness of 200 nm, and a variance of 20 nm that is underlying a second layer with a pattern having a critical dimension with a Weibull distribution, having a given shape and scale parameter and an etch depth having a Beta distribution having given alpha and beta parameters. Examples in commercial embodiments are expected to be substantially more complex, particularly as additional patterned layers are accumulated on a substrate.

In some cases, obtaining the model may be performed as a result of a designer inputting a stack model to a measurement structure simulator. In some embodiments, the measurement structure simulator accepts as an input the attributes of a model, the attributes of one or more measurements (like wavelength of illumination and one or more angles of incidence), and outputs performance indicators for the model. In some embodiments, the measurement structure simulator includes a Maxwell solver like those described above executed in one or more of the computers described below, and the Maxwell solver may calculate the response of the various layers of the model to illumination, e.g., accounting for effects like internal reflections, absorption, reflections, and/or diffraction. In some embodiments, the program code that implements the measurement structure simulator may be stored on a tangible, non-transitory, machine-readable medium, such that when those instructions are executed by one or more processors, the functionality described herein may be effectuated, as is true of the other computer implemented processes described herein. In some embodiments, this medium may be distributed, with different processors having different subsets of the medium executing different subsets of the operations, in which case, the term “medium,” singular, is still used to refer to the arrangement unless otherwise indicated.

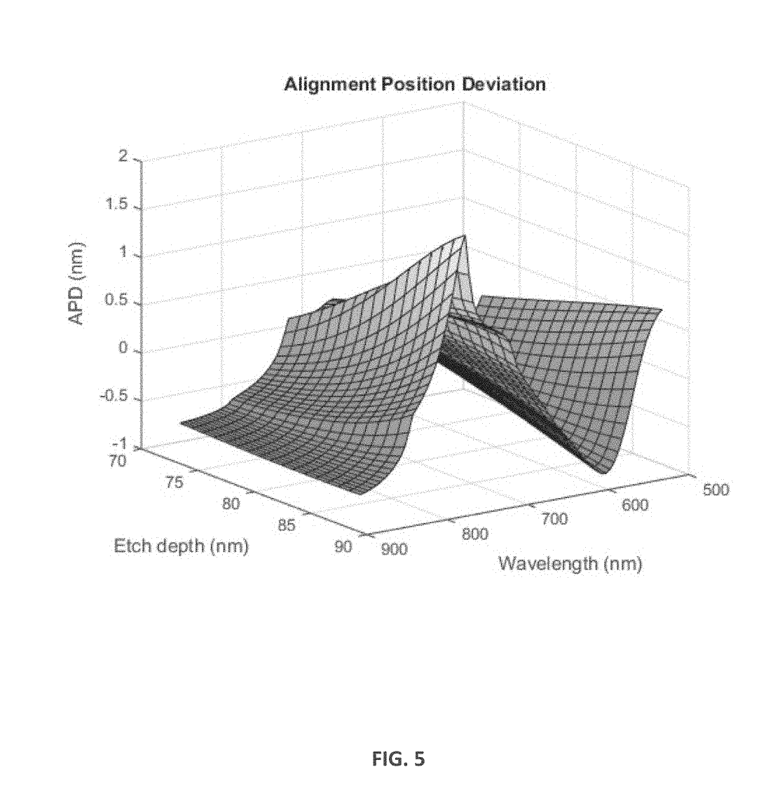

In some embodiments, obtaining the model may be performed at the instruction of a designer designing a patterning process, for instance, before the patterning process is implemented in a semiconductor manufacturing facility. For example, a designer may input a variety of different models and simulate the performance of measurement structures based on the models, as indicated by block 14, to evaluate the various designs. In some embodiments, this may be performed before the patterning process itself is physically performed in order to select a measurement structure likely to exhibit relatively strong performance. In some embodiments, the measurement structure simulator may output graphical representations of performance of the measurement structures, like a heat map and/or three or higher dimensional graphical representations showing performance indicators as a function of various combinations of parameters of the models being varied, for instance, like the graphical representations described below with reference to FIGS. 5 through 7.

In some embodiments, the graphical representations may be caused by the measurement structure simulator to be displayed on a designer's workstation display. In some cases, based on these results, some embodiments include refining a design of the measurement structures based on the simulation, as indicated by block 16. In some cases in an iterative process in which a designer adjusts a design based on graphical representations and other outputs of various simulations on previous iterations is performed. In view of the graphical representations, the designer may select a measurement structure and indicate the selection to the measurement structure simulator by requesting an output of the measurement structure simulator from which the design may be physically embodied, for example, on a patterning device or input into other software to a design pipeline from which a patterning device pattern is formed. For instance, some embodiments may output a graphical database system (GSD)II file, which may be used to form a design layout for a patterning device (or as an input for other patterning processes, like in a direct-write process using e-beams or a radiation pattern formed with a digital micromirror chip).

A variety of different indicators of performance of a measurement structure may be output by the simulation. Examples of measurement structure performance indicators include those described above and/or others, such as stack sensitivity, diffraction efficiency, or “K,” a slope of overlay/asymmetry signal. The performance of a measurement structure is distinct from individual instances of measurements of the structure, e.g., an individual measurement indicating 3 nm of overlay misalignment is not, in and of itself, a “performance indicator,” though it may be used to calculate a performance indicator, for instance, as part of a sample set from which performance is determined.

As noted, in some embodiments, the operations of blocks 12, 14, and 16 may be implemented with a measurement structure simulator executing on one or more processors. The next three blocks may be implemented with a patterning process physically performed in a manufacturing facility, such as a semiconductor manufacturing process. In some embodiments, a patterning device may be configured to provide a pattern to form the measurement structure with the design selected above, often alongside or intermingled with a pattern for a device being formed with the patterning process. In some cases, the measurement structure may be disposed in a scribe line of the pattern, or in some embodiments, the measurement structure may be interspersed within the functional portions of the design.

Some embodiments include fabricating devices and the measurement structures with the patterning process, as indicated by block 18. In some cases, this may include fabricating multiple layers of a measurement structure having a plurality of underlying pattern layers, e.g., two, three, four, five, or more. This may also include aligning subsequent layers to previous layers with one or more alignment marks or other measurement structures patterned in the previous layers. For example, fabricating may include aligning a patterning device (e.g., a reticle) in a lithographic apparatus to an alignment mark in an underlying layer (e.g., underlying a layer to be patterned) in the measurement structure, such as aligning to a grid like that described below with reference to FIG. 2. Fabrication may also include measuring overlay misalignment resulting from patterns being applied. For example, some embodiments may measure overlay misalignment between adjacent patterns formed on the substrate in sequential patterns applied to the substrate, like with a scatterometry metrology tool integrated into the lithographic apparatus or as a standalone tool.

Some embodiments include measuring the performance of the fabricated measurement structures, as indicated by block 20. These empirical measurements may be obtained with the measurements taken during or after the fabrication process, for example, from alignment measurements or overlay measurements. In some cases, performance may be measured by calculating an aggregate value based on a plurality of measurements, for example, an aggregate value indicating a sensitivity of the measurement accuracy to a variation in one or more attributes of the film stack (e.g., a partial or full derivative) or other aspects of the measurement structure. Or some embodiments may obtain other forms of calibration data, e.g., in addition to the empirical measurements or instead of the empirical measurements. For instance, some embodiments may simulate performance over a parameter space of a stack model, and use the simulation results instead of or to supplement the empirical measurements.

Next, some embodiments may determine whether the simulated performance of the measurement structures differ from the empirical measurements, as indicated by block 22. In some cases, this determination may be made by a process engineer determining that the measurement structures are not adequately predicting yield of resulting devices or by determining that alignment marks are not yielding adequate quality overlay measurements. In some cases, this determination may be made when qualifying a new design in a fabrication facility, as part of a process by which the measurement structures are qualified. The amount of difference may be determined with a variety of techniques. Some embodiments may calculate a root mean square difference between performance predicted by the simulation and performance observed through the empirical measurements at a variety of different process variations that were observed in the empirical measurements. Some embodiments may determine whether this root mean square difference exceeds a threshold in the determination of block 22.

Upon determining that the empirical and simulated performance of the measurement structures are not different to at least within a certain degree, some embodiments may return to block 18 and continue fabricating devices.

Alternatively, upon determining that in empirical and simulated performance are sufficiently different (e.g., with an RMS value greater than a threshold), some embodiments may proceed to block 24, which includes a process to calibrate parameters of the model based on the empirical measurements. In some cases, this process may be performed by the above-described measurement structure simulator upon ingesting the empirical measurements, which may include both measurements taken from the measurement structures and measurements indicative of attributes of the measurement structures, like measurements of film thickness, measurements of critical dimensions, measurements of overlay misalignment of underlying layers, and/or the like.

In some embodiments, a subset of the parameters of the model may be calibrated. For instance, some embodiments may calibrate 5 of 20 parameters of the model, or 10 of 50, for instance, corresponding to certain layers in a film stack or certain dimensions, believed to contribute to poor correlation (e.g., less than a threshold RMS value calculated with the technique described above) between the simulation results in the observed results. Or in other embodiments, substantially all, or all, of the parameters of the model may be calibrated. In many cases, the number of parameters calibrated is relatively large, leading to a relatively high dimensional search space in which an optimum fit is to be sought, for instance having more than three or more than five dimensions. Further, the granularity with which the respective dimensions are to be searched may be relatively fine, for instance, with more than five or more than 20 increments per dimension in a range of the search space, again leading to a relatively large number of candidate permutations of the model to be potentially considered when calibrating the model to better match the observed performance of the measurement structures. In some cases, the number of permutations in the parameter space searched in the calibration is greater than 25, e.g., greater than 100.

Next, some embodiments may simulate performance of the measurement structures using a candidate model in the simulation, as indicated by block 26. In some cases, the initial candidate model may be selected arbitrarily, for instance, by randomly selecting parameter values within a search space, or in some cases, the initial candidate model may be the model refined in block 16. In some cases, the initial candidate model may be an adjusted version of that model obtained and refined in block 16, with the adjustment supplied by a knowledgeable engineer based on their judgment as to what they believe may be wrong with the model.

In some embodiments, the candidate model specifies an instance of parameter values in the range of stack parameters to be searched, and in some instances may produce relatively high fitness in the simulation relative to the calibration data (e.g., empirically measured performance or simulated performance). In some cases, the parameter space is defined by a set of parameters, each corresponding to a dimension in the search space (e.g., film thickness of film layer A, film thickness of film layer B, sidewall angle of structure C, critical dimension of structure D, etc., with ranges of values for each dimension). In some cases, the parameters defining dimensions of the searched parameter space are stack parameters, and the stack model may be calibrated to the calibration data.

In some embodiments, the parameter space being searched is high dimensional. In some cases, dimensions of the searched parameter space include attributes of statistical distributions of stack parameters, e.g., a mean and standard deviation of film thickness. Some searched parameter spaces may also include metrology model parameters. In some cases, the searched parameter space includes stack model parameters for multiple measurement structures, in some instances, at different places on an exposure field or substrate, and in some instances at different patterned layers of a film stack. Some embodiments may determine a point in the searched parameter space that corresponds to a global optimum of fitness for the calibration data, where model parameters at the point in the search space produce less aggregate disagreement between simulation results and the calibration data relative to other locations in the parameter search space.

In some embodiments, other types of surrogate functions can be used. For example, function approximation algorithms and systems, such as deep neural networks or ensemble training methods, can be employed. They can be trained in a data driven manner (for instance, with supervised learning). For optimization, apart from Bayesian Optimization, other derivative free techniques may be used. Some embodiments may operate without obtaining an analytical representation of the surrogate function or forward simulator, and algorithms that are based on (e.g., based only on) function evaluation can be used (e.g., Mesh Adaptive Direct Search (MADS), Nonlinear Optimization with the MADS (NOMAD), and Sparse Nonlinear OPTimizer (SNOPT), among others). Alternatively, or additionally, some embodiments may use Hessian matrix or gradient based techniques in combination with automatic differentiation methods.

In some embodiments, the simulation may be performed with the above-described measurement structure simulator. In some cases, the simulation may be relatively computationally expensive and may take a relatively long duration of time, for instance, more than one hour, and in some cases, more than 24 hours, often with a plurality of computing devices, like in a data center having more than five computing devices performing the simulation concurrently in a distributed application. In some embodiments, the simulation may output one or more performance indicators for the candidate model.

Next, some embodiments may approximate the simulation over a range of candidate models, with a surrogate function, as indicated by block 28. In some embodiments, the surrogate function may be faster to compute than the simulation, for instance, with a function amenable to computation on a single computing device in less than two hours for a given iteration. In some embodiments, the surrogate function may approximate a response surface of the simulation over the parameter space of the model in the calibration being performed (i.e., the search space), for instance between a maximum and a minimum of each dimension of the parameter space being evaluated in the calibration. In some embodiments, this response surface may be determined at each of the above-described increments between the maximum and minimum, such as more than five increments. In some cases, this response surface may be in a relatively high dimensional space, as noted above, for instance with more than 5 or more than 20 dimensions. In some cases, this response surface may be recalculated between each iteration of the presently described loop of process 24.

In some embodiments, the surrogate function may approximate a fitness of ranges of corresponding candidate models within the parameter space (e.g., various permutations), where fitness indicates an amount of correspondence between predictions by the simulation (e.g. an approximation thereof with the corresponding candidate model) and the observed empirical measurement structure performance. Examples include an RMS value of differences between predictions and observed results. Thus, at some points in the parameter space, the corresponding candidate models may be expected in the approximation of the surrogate function to produce simulations that relatively closely agree with the observed measurements, yielding a relatively high fitness score output by the surrogate function at those points, while other points in the parameter space, corresponding to other candidate models may be the approximated to produce simulations that are relatively different from the observed measurements, yielding a relatively low fitness score. The term “fitness score” is used generically to encompass one or more various measures of agreement and/or of difference between predictions and observations and, thus, include a cost function that indicates a measure of difference.

In some embodiments, the surrogate function is a probabilistic process, such as a Gaussian process, which yields for each point at which the function is evaluated, a statistical distribution. In some cases, the surrogate function is a probabilistic version of a random forest. In some cases, the surrogate function is a closed form equation that yields a statistical distribution at each point over a range of inputs, like over the parameter space of the calibration, with the statistical distribution indicating the expected distribution of fitness (e.g., accounting for uncertainty). In some cases, the output of the surrogate function at each point in the search space of the model is indicative of both a measure of central tendency of the distribution at the corresponding point in the parameter space and a measure of uncertainty at that point, like a variance for standard deviation of the distribution. Thus, in some embodiments, the approximation may indicate for each of a plurality of candidate models both expected fitness of the candidate model for producing a simulation that corresponds to the observed empirical measurements and uncertainty about the approximation of fitness. In short, the surrogate function may indicate both expected fitness of candidate models throughout the parameter space and uncertainty about that fitness given what is known from fitness of previous simulations.

As explained below, both of these types of outputs of the surrogate function may be adjusted as additional simulations are run for different candidate models, with the measures of central tendency being changed to match or be more closely aligned with simulation results at or near candidate models in the parameter space on which simulations are performed, and with measures of uncertainty decreased or eliminated at or near areas in the parameter space where simulations are run on candidate models.

With these outputs of the surrogate function, some embodiments may select candidate models to simulate next by balancing between goals of 1) exploring areas likely to include the global maximum given what is known (e.g., areas where fitness is high) and 2) exploring areas of the parameter space where little is known (e.g., areas uncertainty is high). In some embodiments, the output of the surrogate function may be input to an acquisition function configured to make the selection, e.g., by assigning a respective score to each point evaluated in the response surface, the scores being based on both fitness and uncertainty. In some embodiments, the selection may weight the uncertainty and the measure of central tendency of the surrogate function in a weighted combination to select where in the parameter space to run a new simulation with a new candidate model. For instance, in some areas of the parameter space, the approximation may have a relatively high fitness with relatively low uncertainty, while other areas may have a lower measure of central tendency of fitness, but a higher measure of uncertainty that exceeds that of the first areas. Some embodiments may balance between these opportunities with a weighting parameter that balances between exploring areas of the parameter space where little is known but a global maximum possibly occurs and exploring areas of the parameter space where much is known and based on what is known the global maximum may occur. This balance may be indicated in the score output by the acquisition function for each point evaluated in the parameter space of the model. Some embodiments may select a highest scoring point in the parameter space of the model as the next candidate model, e.g., by calculating a result of the acquisition function with a brute force search over the parameter space for a highest score (or lowest score if multiplied by −1).

In some embodiments, the weighting between uncertainty and the measure of central tendency in selecting a next candidate model may be adjusted as iterations progress. For example, some embodiments may decrease the effect of uncertainty in selecting the next candidate model and increase the effect of the measure of central tendency of the surrogate function output at given points in the parameter space of the calibration of the model as the calibration proceeds. Thus, in some embodiments, early in a calibration, some embodiments may favor exploration of areas in which little is known over exploration of areas in which the results so far indicate are likely to have relatively high fitness, as compared to areas selected for exploration later in the calibration, when the new candidate model is less likely to be selected in areas of uncertainty. Examples of acquisition functions are described in Brochu.

A variety of different types of acquisition functions may be used to select a candidate model, as indicated by block 29. Examples include those described in Brochu.

Next, some embodiments may determine whether a termination condition is true, as indicated by block 30. Repeating operations until a termination condition is true includes performing those operations once if the termination condition is true upon a single iteration. A variety of different types of termination conditions may be used to determine whether to stop the calibration. Examples include a fixed number of iterations, with a determination as to whether a count incremented with each iteration is above a threshold. Other examples include determining whether a change in an optimal fitness produced by the surrogate function between iterations is less than a threshold. Some embodiments may determine whether a residual amount of uncertainty over the parameter space is less than a threshold, for instance calculated as an RMS value over the search space. Some embodiments may determine whether a change in the Euclidean distance between subsequent selections of the candidate model in the parameter space is less than a threshold distance. Some embodiments may determine whether the result of a simulation is no longer different under the test described above with respect block 22 within a certain degree relative to the observed empirical measurement performance.

Upon determining that the termination condition is false, some embodiments may return to block 26 and repeat another iteration of the calibration routine 24, using the newly selected candidate model. As indicated above, the selection may be in an area of the parameter space the model that is likely to include a global optimum or rule out an area of uncertainty in which a global optimum is relatively likely to occur. With this technique, embodiments may relatively carefully select areas of the parameter space in which to run each simulation, and some embodiments may identify a global optimum with relatively few iterations of the full simulation, which as noted above are relatively computationally expensive, while identifying a global optimum of fitness of the calibrated model for yielding simulations that match the observed performance of the fabricated measurement structures.

Upon determining that the termination condition is true, some embodiments may proceed to block 32 and store the calibrated parameters of the model in memory. In some cases, the calibrated model may be used to re-simulate performance of measurement structures, as indicated by block 14. In some embodiments, the performance of a measurement structure may be further improved with further refinement, fabrication, and measurements, in accordance with the techniques described above, using the improved, calibrated model. Or in some cases, other aspects of the measurement process may be adjusted with the calibrated model. For example, a different frequency of radiation may be used, different calculations may be used to convert measured signals into distances of overlay or alignment, and/or the like.

As noted, the models being calibrated may be relatively high-dimensional. FIG. 2 shows one example of a measurement structure 36 used in a patterning process that illustrates the relatively computationally complex nature of the calibration process. In FIG. 2, measurement structure 36 is shown in a vertical cross-sectional view that illustrates some of the various parameters of a model that may be calibrated with the above techniques. In this example, a pattern 33 (e.g., of patterned photoresist, or after etching, prior to an overlay measurement) is shown having been patterned over another patterned layer 40. The amount of alignment or misalignment of layers 33 and 40 may be measured with scatterometry or other techniques. In some cases, before patterning the layer 33, a lithographic apparatus or other patterning equipment may be aligned to the underlying layer 40 using portions of the measurement structure 36 already present. As illustrated, in this example, the measurement structure 36 includes overlaid gratings in layers 33 and 40 that may facilitate sub-wavelength sensing of overlay alignment within the lithographic apparatus and within metrology equipment that measures overlay.

Examples of model parameters include pitch 40, critical dimension 42, etch depth 44, film thickness 46, and/or various attributes of the profiles of the structures formed, like sidewall angle, curvature of the corners, surface roughness, and/or the like. In some cases, the model also includes the composition of the various layers or optical properties thereof. In some cases, the model further includes statistical distributions of these parameters expected to occur in the manufacturing process.

In some cases, the surrogate function for the candidate model may be initialized based on what is known or believed to be likely ranges for some or all of these parameters of a model, reflecting the current state of knowledge about both what is known and what is unknown. Embodiments may then iteratively simulate in selected areas of the parameter space to identify a global maximum of fitness of correspondence with the observed empirical measurements. FIG. 2 serves to illustrate the relatively high dimensional nature of the task, which may present challenges compounded by things like local maximums and other nonlinear interactions between various parameters of the model and fitness that can cause other techniques for determining an optimum candidate model to yield inferior results, which is not to suggest that any other techniques for calibrating are disclaimed. For instance, other approaches like a gradient descent may be used to refine a calibration result in a relatively small search space.

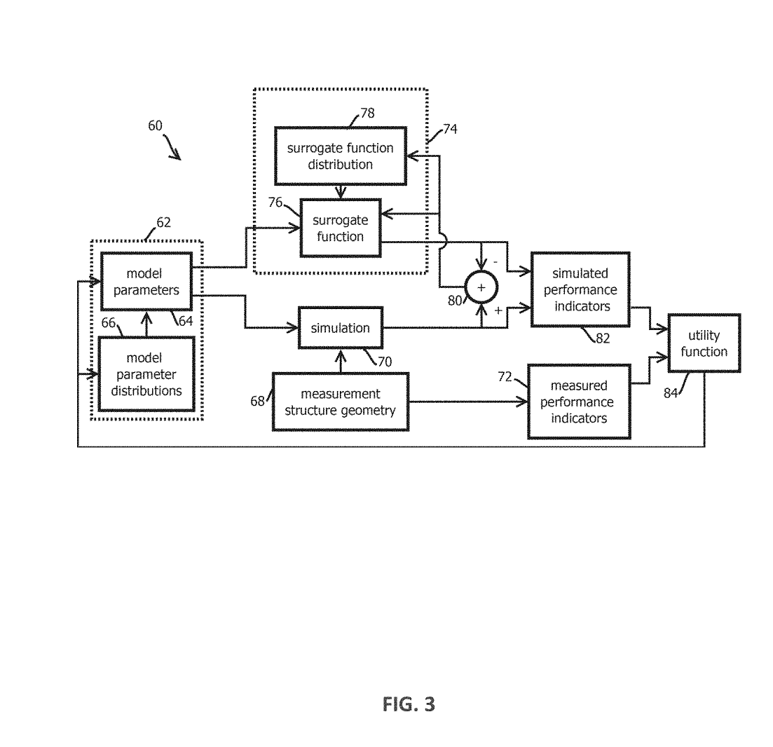

FIG. 3 shows an example of a block diagram of information flow 60 in a process of calibrating a model in accordance with the techniques described herein. In some embodiments, an existing model used in simulation is obtained, as indicated by block 62, which may serve as an initial candidate model in the above-described process. In some cases, the model includes both model parameters 64, and model parameter distributions 66, for instance ranges of process variation of the model parameters. The parameters may be both fed into a simulation approximation 74 and a simulation 70. The simulation 70 may be performed with the above-described measurement structure simulator, which as noted may be a relatively computationally expensive process. The simulation may account for the geometry of the measurement structure, as indicated by block 68, for instance, the nominal or target design of the measurement structure and in some cases distributions thereof. In some embodiments, the approximation 74 is based on a surrogate function 76 and a surrogate function distribution 78 and is a Gaussian process or other statistical process, which may yield at each point in a parameter space of the candidate models a measure of central tendency, like a mean, mode, or median, of fitness in predicting the observed measurements of performance of measurement structures and a measure of uncertainty, like a variance for standard deviation.

In some embodiments, the simulation 70 may be combined with the approximation 74, as indicated by operator 80 to improve the approximation. In some cases, this may be characterized as training the surrogate function based on simulation results. The approximation 74 and the simulation 70 may yield simulated performance indicators 82 which may be compared with the empirically measured performance indicators 72 using a utility function 84 to determine fitness of the candidate model or other candidate models. In some cases, the utility function 84 selects a new candidate model based on what is known from the simulation 70 and the approximation 74, for instance with the above-described acquisition function. This new candidate model may be fed back into the model 62 which may be input to the above-described process in another iteration until the process converges on a global optimum. Thus, as illustrated in FIG. 3, some embodiments may concurrently execute two feedback loops in which both the model is trained and the surrogate function approximating the simulation is trained on simulation results, in some cases, on multiple measurement structures and overlapping sets of parameters for models used to simulate those measurement structures.

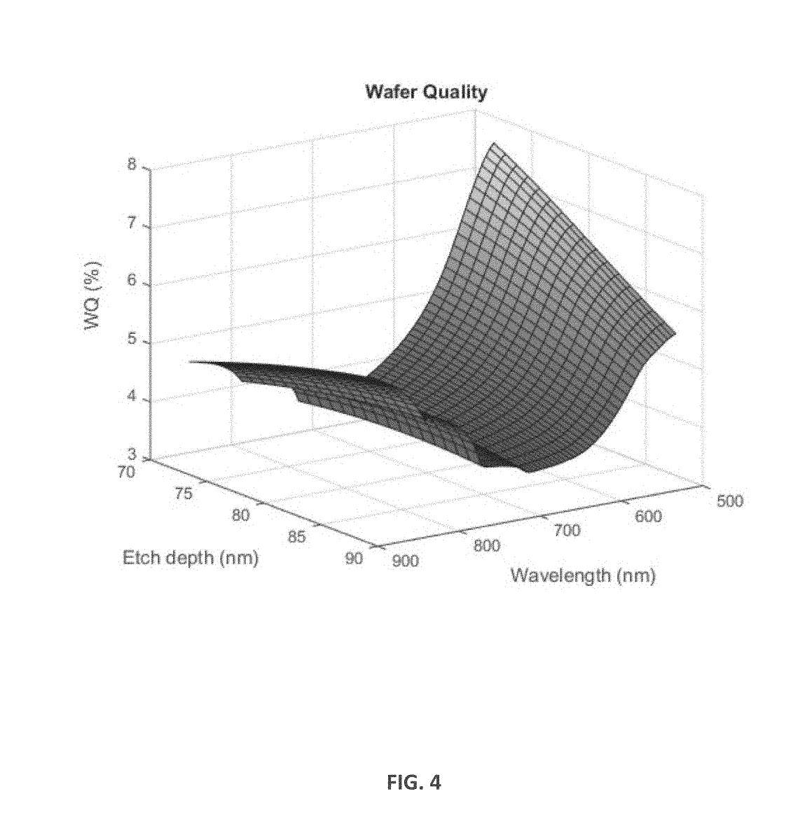

In many cases, calibrating model parameters is made more challenging by a relatively rough energy landscape of the fitness function. The complexity of the stack response surface is illustrated by the following example calculation using simulated alignment on a subsegmented alignment mark with a simple stack. FIGS. 4 and 5 shows respective slices through wafer quality (WQ) and alignment position deviation (APD) response surfaces. In this case, the mark etch depth is varied and plotted as function of alignment wavelength used to illuminate the measurement structure during alignment.

In some cases, depending on the alignment sensor, specific wavelengths in the range between 530 and 880 nm may be measured simultaneously. Etch depth is one of the typically uncertain sensitive parameters which may be tuned to experimental values using the techniques above. In some cases, sensitivity to etch-depth changes in the stack and varies in sign and magnitude from layer to layer. In some cases, this sensitivity is also correlated with other stack/grating parameters of a model.

Specifically, FIGS. 4 and 5 show WQ and APD response of a subsegmented alignment mark as function of alignment wavelength and etch depth. At each set of stack parameters, simulated performance indicators may be computed to be optimized towards measured values. A variety of performance indicators (KPIs) are contemplated and include detectability KPIs and an accuracy KPI. Detectability KPIs include WQ and the accuracy KPI is designed to monitor process stability and accuracy. The latter may be computed from (wavelength-dependent) APD and measurement reproducibility values, both of which may be direct outputs from a measurement structure performance simulator.

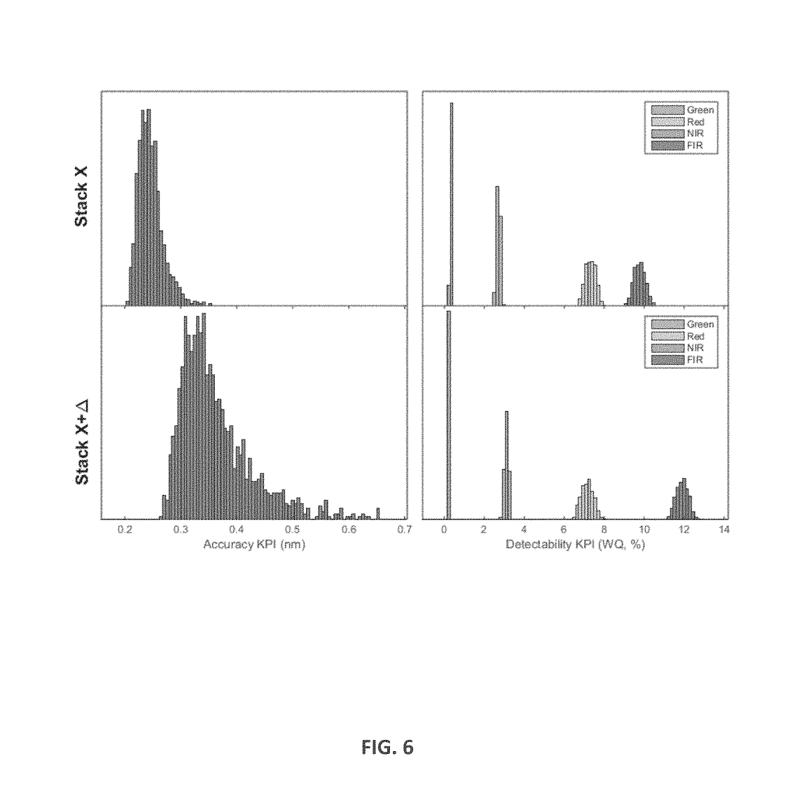

As an example, FIG. 6 shows these KPIs, calculated at two sets of stack parameters, X and X+A, where A in this case is a 5% change in etch bias and a 10% change in etch depth. Distributions of the KPIs may be obtained from 1500 Monte Carlo samples over process variations which include 2.5 degrees of etch asymmetrical sidewall angle, 2.5 nm etch floor tilts, and 10% variation on the various layer thicknesses. Results show how KPI response due to stack changes are wavelength dependent and how the width of the distributions indicate sensitivity to process variations, in this example.

Thus, accuracy and detectability KPIs may be translated into a utility function used in hyperparameter tuning and surrogate function training.

Through these techniques, embodiments may achieve one or more of the following:
A principled way to do stack tuning in complex and expensive simulations of metrology target (or other type of measurement structure) design.
Infer posterior beliefs on quality or relevance of certain stack parameters for certain types of metrology targets, by deploying a Bayesian hierarchical model. For example, multilevel models may be fitted by using Markov Chain Monte Carlo methods, and some embodiments may optimize the parameters of this model through Bayesian Optimization, e.g. using a multilevel model as surrogate function.
Alignment and overlay target optimization may be cast into the same framework, which is expected to improve the accuracy with which the stack tuning parameters are inferred (estimated). Some embodiments combine the alignment marker and overlay target optimizations concurrently into one overall optimization flow, governed by a common set of (stack-) hyperparameters. Thus, some embodiments use both alignment and overlay target simulation models to fine tune difficult to optimize stack parameters.
Optimally using vendor-unique measurements (e.g., alignment, and scatteromentry critical dimension measurement structures) in conjunction with overlay metrology to mutually improve common governing parameter estimates, thereby potentially improving individual functionality in turn.
Possibility to detect missing data (e.g., a layer not specified) when predictive uncertainty is too large to make reasonable predictions or the model is underspecified.
Providing a natural way to put a priori knowledge on typical parameter ranges in the method (prior distributions), leading to ‘soft-constraints’ on the parameters.
Algorithmic benefits of using a Bayesian Optimization approach, such as performing well on a noisy solution space; reducing the number of expensive functional evaluations (e.g. full simulations); and/or different surrogate functions are expected to provide a good trade-off on complexity and accuracy.

Hence, the some embodiments may improve the accuracy of the joint hyperparameter (distribution) estimation.

In addition, existing forward models like scatterometry metrology tool critical dimension library-based reconstruction may be reused to provide even more information on hyperparameter adaptation, by adding it to the simultaneous inference task serving all three modules (alignment mark & overlay target design, CD reconstruction), assuming again shared (stack-) hyperparameters

A variety of applications of the present techniques are contemplated and include:

1. Stack tuning under uncertainty

2. Data integrity or quality assessment

3. Speeding up computations by homing in to potential solutions quickly

4. Inferring stack variations based on on-line overlay and alignment measurements, for possibly improved monitoring KPIs. Both overlay as well as alignment measurements may be done regularly both intra-wafer as well as intra-lot. This information may be then used to monitor the stability of the stack parameters and have a mechanism of flagging excursions that threaten the validity of alignment and/or overlay metrology recipes.

5. Add structure on the hyper(stack-)parameters (e.g. for various types of devices, like DRAM, logic, other types), and increase accuracy per group by adding info from new simulation simulations built up knowledge from multiple simulations.

6. Rank optimal candidate marks and targets based on expected utility and posterior stack uncertainty, e.g., ‘cheaper’ mark with slightly worse process sensitivity at high stack parameter uncertainty may be preferred over a slightly more accurate but ‘expensive’ mark.

7. Ranking of the most informative measurements to reduce uncertainty on the (stack-) hyperparameters.

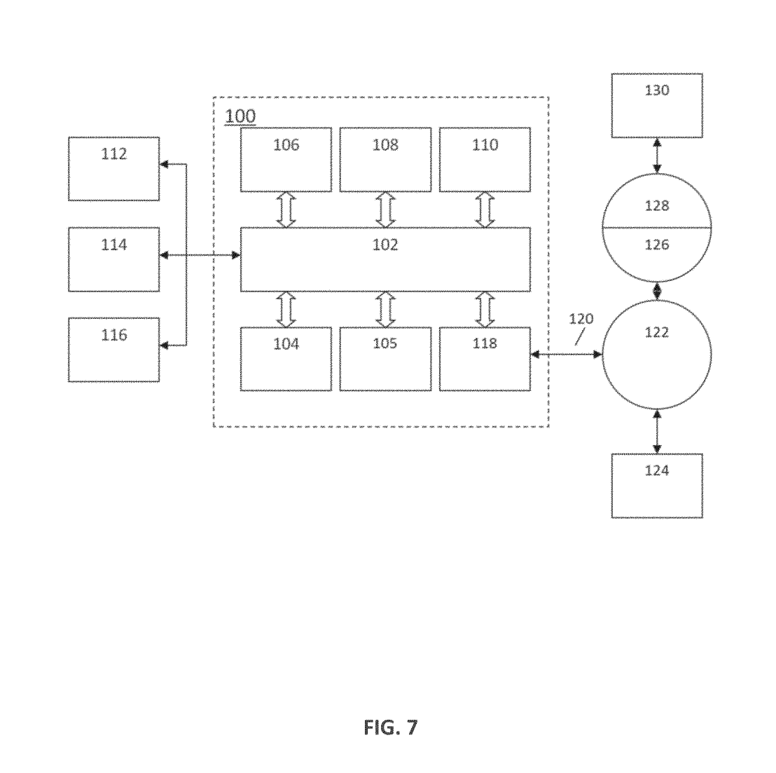

FIG. 7 is a block diagram that illustrates a computer system 100 that may assist in implementing the simulation, characterization, and/or qualification methods and flows disclosed herein. Computer system 100 includes a bus 102 or other communication mechanism for communicating information, and a processor 104 (or multiple processors 104 and 105) coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or flat panel or touch panel display for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane. A touch panel (screen) display may also be used as an input device.

According to one embodiment, portions of the optimization process may be performed by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform one or more of the process steps described herein. One or more processors in a multi-processing arrangement may also be employed to execute the sequences of instructions contained in main memory 106. In an alternative embodiment, hard-wired circuitry may be used in place of or in combination with software instructions. The computer need not be co-located with the patterning system to which an optimization process pertains. In some embodiments, the computer (or computers) may be geographically remote.

The term “computer-readable medium” as used herein refers to any tangible, non-transitory medium that participates in providing instructions to processor 104 for execution. Such a medium may take many forms, including non-volatile media and volatile media. Non-volatile media include, for example, optical or magnetic disks or solid state drives, such as storage device 110. Volatile media include dynamic memory, such as main memory 106. Transmission media include coaxial cables, copper wire and fiber optics, including the wires or traces that constitute part of the bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge. In some embodiments, transitory media may encode the instructions, such as in a carrier wave.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 may also include a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120, and communication interface 118. In the Internet example, a server 130 might transmit a requested code for an application program through Internet 128, ISP 126, local network 122 and communication interface 118. One such downloaded application may provide for execution of one or more process steps described herein. The received code may be executed by processor 104 as it is received, and/or stored in storage device 110, or other non-volatile storage for later execution. In this manner, computer system 100 may obtain application code in the form of a carrier wave.

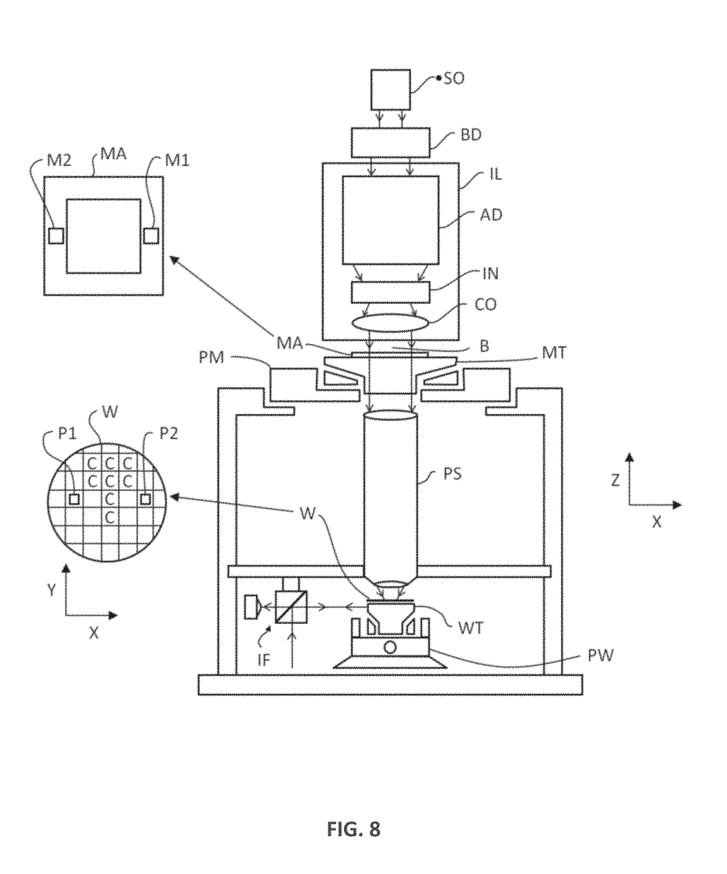

FIG. 8 schematically depicts an exemplary lithographic projection apparatus whose process window for a given process may be characterized with the techniques described herein. The apparatus includes in this example:
an illumination system IL, to condition a beam B of radiation. In this particular case, the illumination system also comprises a radiation source SO;
a first object table (e.g., patterning device table) MT provided with a patterning device holder to hold a patterning device MA (e.g., a reticle), and connected to a first positioner to accurately position the patterning device with respect to item PS;
a second object table (substrate table) WT provided with a substrate holder to hold a substrate W (e.g., a resist coated silicon wafer), and connected to a second positioner to accurately position the substrate with respect to item PS;
a projection system (“lens”) PS (e.g., a refractive, catoptric or catadioptric optical system) to image an irradiated portion of the patterning device MA onto a target portion C (e.g., comprising one or more dies) of the substrate W.

As depicted herein, the apparatus is of a transmissive type (i.e., has a transmissive patterning device). However, in general, it may also be of a reflective type, for example (with a reflective patterning device). The apparatus may employ a different kind of patterning device to classic mask; examples include a programmable mirror array or LCD matrix.

The source SO (e.g., a mercury lamp or excimer laser, LPP (laser produced plasma) EUV source) produces a beam of radiation. This beam is fed into an illumination system (illuminator) IL, either directly or after having traversed conditioning means, such as a beam expander Ex, for example. The illuminator IL may comprise adjusting means AD for setting the outer and/or inner radial extent (commonly referred to as □-outer and □-inner, respectively) of the intensity distribution in the beam. In addition, it will generally comprise various other components, such as an integrator IN and a condenser CO. In this way, the beam B impinging on the patterning device MA has a desired uniformity and intensity distribution in its cross section.

It should be noted with regard to FIG. 8 that the source SO may be within the housing of the lithographic projection apparatus (as is often the case when the source SO is a mercury lamp, for example), but that it may also be remote from the lithographic projection apparatus, the radiation beam that it produces being led into the apparatus (e.g., with the aid of suitable directing mirrors); this latter scenario is often the case when the source SO is an excimer laser (e.g., based on KrF, ArF or F2 lasing).

The beam PB subsequently intercepts the patterning device MA, which is held on a patterning device table MT. Having traversed the patterning device MA, the beam B passes through the lens PL, which focuses the beam B onto a target portion C of the substrate W. With the aid of the second positioning means (and interferometric measuring means IF), the substrate table WT can be moved accurately, e.g. so as to position different target portions C in the path of the beam PB. Similarly, the first positioning means can be used to accurately position the patterning device MA with respect to the path of the beam B, e.g., after mechanical retrieval of the patterning device MA from a patterning device library, or during a scan. In general, movement of the object tables MT, WT will be realized with the aid of a long-stroke module (coarse positioning) and a short-stroke module (fine positioning), which are not explicitly depicted in FIG. 8. However, in the case of a stepper (as opposed to a step-and-scan tool) the patterning device table MT may just be connected to a short stroke actuator, or may be fixed.

The depicted tool can be used in two different modes:
In step mode, the patterning device table MT is kept essentially stationary, and an entire patterning device image is projected in one go (i.e., a single “flash”) onto a target portion C. The substrate table WT is then shifted in the x and/or y directions so that a different target portion C can be irradiated by the beam PB;
In scan mode, essentially the same scenario applies, except that a given target portion C is not exposed in a single “flash”. Instead, the patterning device table MT is movable in a given direction (the so-called “scan direction”, e.g., the y direction) with a speed v, so that the projection beam B is caused to scan over a patterning device image; concurrently, the substrate table WT is simultaneously moved in the same or opposite direction at a speed V=Mv, in which M is the magnification of the lens PL (typically, M=¼ or ⅕). In this manner, a relatively large target portion C can be exposed, without having to compromise on resolution.

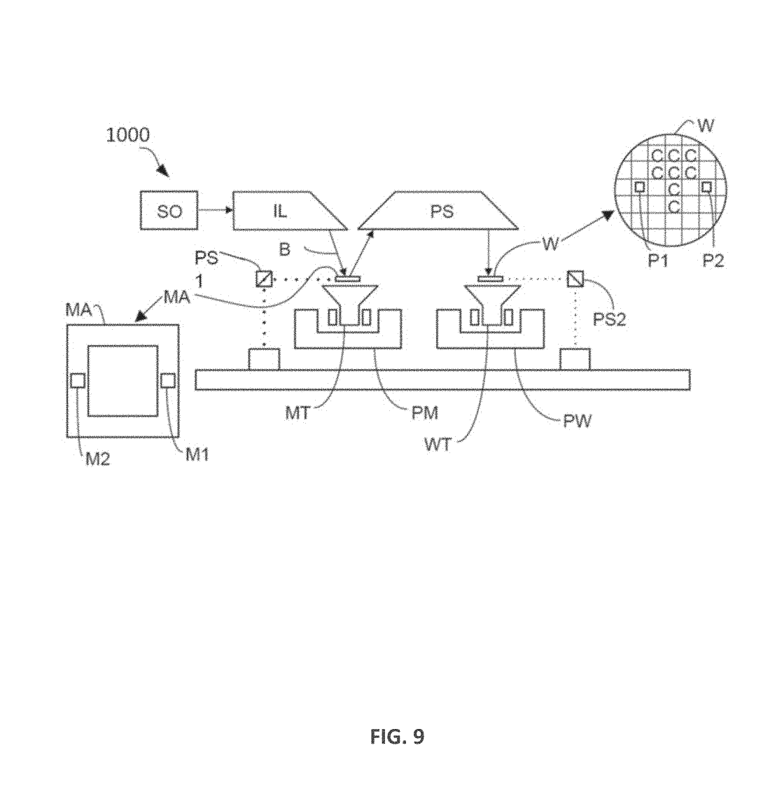

FIG. 9 schematically depicts another exemplary lithographic projection apparatus 1000 whose process window for a given process may be characterized with the techniques described herein.

The lithographic projection apparatus 1000, in some embodiments, includes:
a source collector module SO
an illumination system (illuminator) IL configured to condition a radiation beam B (e.g. EUV radiation).
a support structure (e.g. a patterning device table) MT constructed to support a patterning device (e.g. a mask or a reticle) MA and connected to a first positioner PM configured to accurately position the patterning device;
a substrate table (e.g. a wafer table) WT constructed to hold a substrate (e.g. a resist coated wafer) W and connected to a second positioner PW configured to accurately position the substrate; and
a projection system (e.g. a reflective projection system) PS configured to project a pattern imparted to the radiation beam B by patterning device MA onto a target portion C (e.g. comprising one or more dies) of the substrate W.
As here depicted, the apparatus 1000 is of a reflective type (e.g. employing a reflective patterning device). It is to be noted that because most materials are absorptive within the EUV wavelength range, the patterning device may have multilayer reflectors comprising, for example, a multi-stack of Molybdenum and Silicon. In one example, the multi-stack reflector has a 40 layer pairs of Molybdenum and Silicon where the thickness of each layer is a quarter wavelength. Even smaller wavelengths may be produced with X-ray lithography. Since most material is absorptive at EUV and x-ray wavelengths, a thin piece of patterned absorbing material on the patterning device topography (e.g., a TaN absorber on top of the multi-layer reflector) defines where features would print (positive resist) or not print (negative resist).

As shown in FIG. 9, in some embodiments, the illuminator IL receives an extreme ultra violet radiation beam from the source collector module SO. Methods to produce EUV radiation include, but are not necessarily limited to, converting a material into a plasma state that has at least one element, e.g., xenon, lithium or tin, with one or more emission lines in the EUV range. In one such method, often termed laser produced plasma (“LPP”) the plasma can be produced by irradiating a fuel, such as a droplet, stream or cluster of material having the line-emitting element, with a laser beam. The source collector module SO may be part of an EUV radiation system including a laser, not shown in FIG. 9, for providing the laser beam exciting the fuel. The resulting plasma emits output radiation, e.g., EUV radiation, which is collected using a radiation collector, disposed in the source collector module. The laser and the source collector module may be separate entities, for example, when a CO2 laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors or a beam expander. In other cases the source may be an integral part of the source collector module, for example when the source is a discharge produced plasma EUV generator, often termed as a DPP source.

The illuminator IL may include an adjuster for adjusting the angular intensity distribution of the radiation beam. Generally, at least the outer or inner radial extent (commonly referred to as σ-outer and σ-inner, respectively) of the intensity distribution in a pupil plane of the illuminator can be adjusted, in some embodiments. In addition, the illuminator IL may include various other components, such as facetted field and pupil mirror devices. The illuminator may be used to condition the radiation beam, to have a desired uniformity and intensity distribution in its cross section.

The radiation beam B is incident on the patterning device (e.g., mask) MA, which is held on the support structure (e.g., patterning device table) MT, and is patterned by the patterning device, in this example. After being reflected from the patterning device (e.g., mask) MA, the radiation beam B passes through the projection system PS, which focuses the beam onto a target portion C of the substrate W. With the aid of the second positioner PW and position sensor PS2 (e.g., an interferometer, linear encoder or capacitive sensor), the substrate table WT can be moved accurately, e.g., so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using patterning device alignment marks M1, M2 and substrate alignment marks P1, P2.

The depicted apparatus 1000 may be used in at least one of the following modes:

1. In step mode, the support structure (e.g. patterning device table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.
2. In scan mode, the support structure (e.g. patterning device table) MT and the substrate table WT are scanned synchronously while a pattern imparted to the radiation beam is projected onto a target portion C (i.e. a single dynamic exposure). The velocity and direction of the substrate table WT relative to the support structure (e.g. patterning device table) MT may be determined by the (de-)magnification and image reversal characteristics of the projection system PS.
3. In another mode, the support structure (e.g. patterning device table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that uses programmable patterning device, such as a programmable mirror array of a type as referred to above.

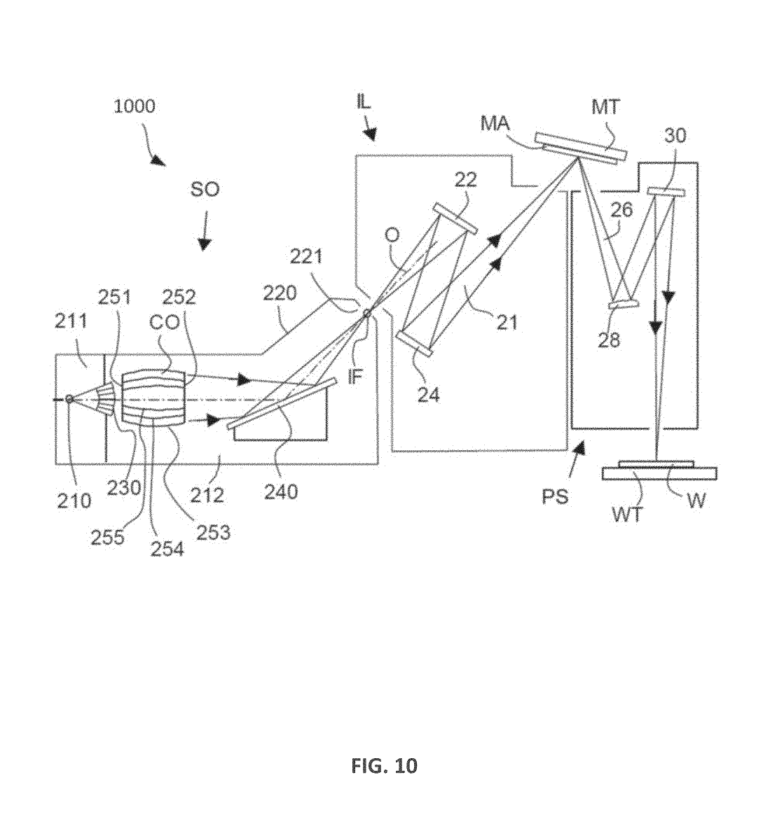

FIG. 10 shows the apparatus 1000 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing an at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 211 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF along the optical axis indicated by the dot-dashed line ‘O’. The virtual source point IF is commonly referred to as the intermediate focus, and the source collector module is arranged such that the intermediate focus IF is located at or near an opening 221 in the enclosing structure 220. The virtual source point IF is an image of the radiation emitting plasma 210.

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the substrate table WT.

More elements than shown may generally be present in illumination optics unit IL and projection system PS. The grating spectral filter 240 may optionally be present, depending upon the type of lithographic apparatus. Further, there may be more mirrors present than those shown in the figures, for example there may be 1-6 additional reflective elements present in the projection system PS than shown in FIG. 10.

Collector optic CO, as illustrated in FIG. 10, is depicted as a nested collector with grazing incidence reflectors 253, 254 and 255, just as an example of a collector (or collector mirror). The grazing incidence reflectors 253, 254 and 255 are disposed axially symmetric around the optical axis O and a collector optic CO of this type may be used in combination with a discharge produced plasma source, often called a DPP source.

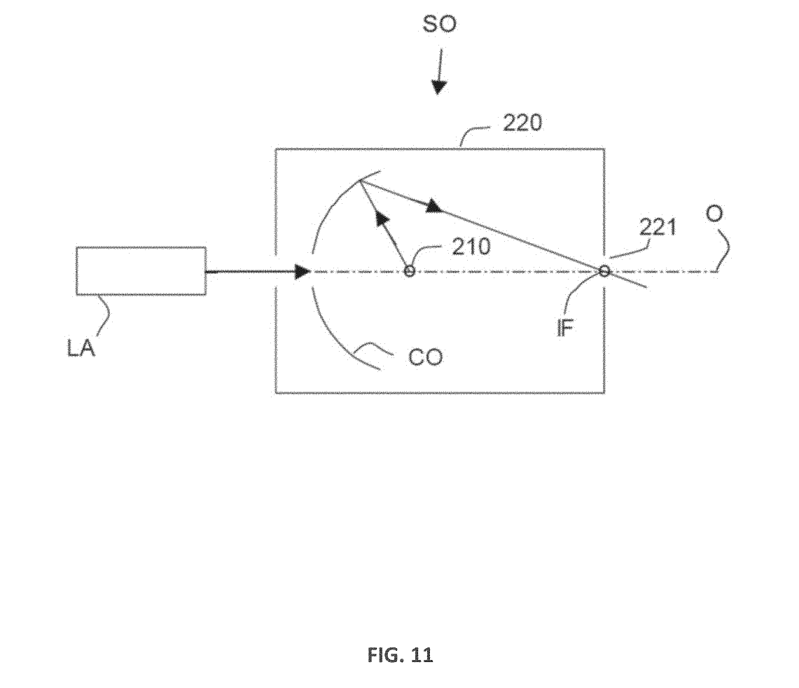

Alternatively, the source collector module SO may be part of an LPP radiation system as shown in FIG. 11. A laser LA is arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector optic CO and focused onto the opening 221 in the enclosing structure 220.

U.S. Patent Application Publication No. US 2013-0179847 is hereby incorporated by reference in its entirety.

The concepts disclosed herein may simulate or mathematically model any generic imaging system for imaging sub wavelength features, and may be especially useful with emerging imaging technologies capable of producing increasingly shorter wavelengths. Emerging technologies already in use include EUV (extreme ultra violet), DUV lithography that is capable of producing a 193 nm wavelength with the use of an ArF laser, and even a 157 nm wavelength with the use of a Fluorine laser. Moreover, EUV lithography is capable of producing wavelengths within a range of 20-5 nm by using a synchrotron or by hitting a material (either solid or a plasma) with high energy electrons in order to produce photons within this range.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 100 may be transmitted to computer system 100 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium.

The present techniques will be better understood with reference to the following enumerated clauses:

1. A method of calibrating parameters of a stack model used to simulate the performance of alignment marks, overlay metrology targets, or other measurement structures in patterning processes, the method comprising: obtaining, with one or more processors, a stack model used in a simulation of performance of measurement structures used in a patterning process; obtaining, with one or more processors, calibration data indicative of performance of the measurement structures in the patterning process, the calibration data being empirical measurements or results of simulations of performance of the measurement structures; after obtaining the empirical measurements, with one or more processors, calibrating parameters of the stack model by, until a termination condition occurs, repeatedly: simulating performance of the measurement structures with the simulation using a candidate stack model having candidate-model parameters; approximating the simulation over a range of candidate stack models, based on a result of the simulation, with a surrogate function that is faster to compute than the simulation, wherein the surrogate function: takes as an input candidate stack models having candidate-model parameters, and outputs both a measure of fitness and a measure of uncertainty about fitness, wherein fitness is indicative of differences between approximated simulation results based on input candidate stack models and the obtained calibration data; and selecting a new candidate model based on the approximation; and storing, with one or more processors, the calibrated parameters of the stack model in memory.
2. The method of clause 1, wherein calibrating parameters of the stack model comprises calibrating a stack model of a patterned film stack in which the alignment marks, overlay metrology targets or other measurement structures are formed, wherein calibrating is performed with a Bayesian optimization using the surrogate function fitted to simulation results.
2.1 The method of clause 1 or clause 2, wherein calibrating parameters of the stack model comprises concurrently calibrating parameters of a plurality of models of a plurality of measurement structures, the plurality of measurement structures including an alignment mark, an overlay metrology target, a critical dimension metrology target, a plurality of alignment marks, a plurality of overlay metrology targets, a plurality of critical dimension metrology targets, or a combination selected therefrom.
3. The method of any of clauses 1 to 2.1, comprising determining that a previous model results in a simulation that does not correctly predict the performance of the measurement structures in the patterning processes, wherein: calibrating is performed in response to the determination, and the calibration causes the previous model to change such that the simulation more closely matches the obtained empirical measurements relative to simulations based on the previous model.
4. The method of any of clauses 1 to 3, wherein approximating the simulation with the surrogate function comprises: approximating an aggregate measure of differences between the empirical measurements and the simulation over a range of candidate models as a Gaussian process, wherein the measure of fitness is a mean of the Gaussian process and the measure of uncertainty is a variance or standard deviation of the Gaussian process.
5. The method of any of clauses 1 to 4, wherein approximating the simulation over a range of candidate stack models, based on a result of the simulation, with a surrogate function comprises: obtaining a prior version of the surrogate function; and transforming the prior version of the surrogate function into a posterior version of the surrogate function based on a data likelihood function and the results of the simulation with Bayes' rule of inference.
6. The method of any of clauses 1 to 5, wherein the simulation is configured to simulate responses of alignment marks, overlay metrology targets or other measurement structures to process variation by varying parameters of the stack model, the parameters including film thickness, etch depth, line-width, and/or line-pitch, and simulating results of the variations.
7. The method of any of clauses 1 to 6, wherein approximating the simulation over a range of candidate models comprises root-mean-square values of performance indicator differences between approximated simulation results based on input candidate models and the obtained empirical measurements.
8. The method of any of clauses 1 to 7, wherein the performance of measurement structures is indicative of a ratio of change in a parameter of the model to a change in a measure of alignment.
9. The method of any of clauses 1 to 8, calibrating parameters of the stack model comprises: repeatedly, in at least some iterations, training the surrogate function based on simulation results.
10. The method of any of clauses 1 to 9, wherein: the measurement structures comprise a grating at least partially overlapping another grating in a film stack; and more than four parameters of the model are concurrently calibrated with a global optimization.
11. The method of any of clauses 1 to 10, wherein at least some adjustments to the stack model are not based on a gradient descent of a function based on the simulation and the empirical measurements, and wherein calibration is performed without using a closed form equation expression of the simulation.
12. The method of any of clauses 1 to 11, wherein the surrogate function correlates points in a parameter space of the model with respective statistical distributions of outputs at the respective points.
13. The method of clause 12, comprising adjusting the surrogate function based on the result of the simulation by: for a point in the parameter space of the model upon which the simulation is based: aligning a measure of central tendency of the respective statistical distribution to the result of the simulation; and reducing or eliminating a measure of variance of the respective statistical distribution; and for a point in the parameter space adjacent the point upon which the simulation is based: adjusting a measure of central tendency of the respective statistical distribution to be closer to the result of the simulation; and reducing a measure of variance of the respective statistical distribution.
14. The method of any of clauses 1 to 13, wherein selecting a new candidate stack model based on the approximation comprises determining candidate stack model parameters by determining an extremum of an acquisition function that is based on both the measure of fitness and the measure of uncertainty about fitness,
15. The method of clause 14, wherein: the extremum is a global maximum; between repetitions of the calibration, adjusting a parameter of the acquisition function to change relative effects of the measure of fitness and the measure of uncertainty about fitness to decrease an amount of effect on the acquisition function by the measure of uncertainty about fitness and increase an amount of effect on the acquisition function by the measure of fitness.
16. The method of any of clauses 1 to 15, wherein calibrating parameters of the stack model comprises steps for calibrating parameters of a model.
17. The method of any of clauses 1 to 16, wherein calibrating parameters of the stack model comprises calibrating parameters of statistical distributions of parameters of the stack model.
18. The method of any of clauses 1 to 17, wherein calibrating parameters of the model comprises using simulations of both alignment mark performance and overlay metrology target performance to infer a plurality of parameters of a film stack with which both alignment marks and overlay metrology targets are formed.
19. The method of any of clauses 1 to 18, comprising: simulating performance of the measurement structures with the calibrated parameters of the model; causing a calibrated simulation result to be displayed to a user; receiving, from the user, an adjustment to the measurement structures; and patterning a plurality of substrates based on measurements of the measurement structures.
20. A tangible, non-transitory, machine readable media storing instructions that when executed by a data processing apparatus effectuate operations comprising the operations of any of clauses 1 to 19.
21. A system comprising: one or more processors; and memory storing instructions that when executed effectuate operations comprising the operations of any of clauses 1 to 19.
22. A method of calibrating parameters of a stack model used to simulate the performance of alignment marks, overlay metrology targets, or other measurement structures in patterning processes, the method comprising:

obtaining, with one or more processors, a stack model used in a simulation of performance of measurement structures used in a patterning process;

obtaining, with one or more processors, calibration data indicative of performance of the measurement structures in the patterning process, the calibration data being empirical measurements or results of simulations of performance of the measurement structures;

after obtaining the calibration data, with one or more processors, calibrating parameters of the stack model by, until a termination condition occurs, repeatedly:
performing the simulation of performance of measurement structures using a candidate stack model having candidate-model parameters;
approximating the simulation over a range of candidate stack models, based on a result of the simulation, with a surrogate function, wherein the surrogate function:
   takes as an input candidate stack models having candidate-model parameters, and
   outputs a measure of fitness and/or a measure of uncertainty about fitness, wherein fitness is indicative of differences between approximated simulation results based on input candidate stack models and the obtained calibration data; and
   selecting a new candidate model based on the measure of fitness and/or measure of uncertainty about fitness;
      23. A method of calibrating parameters of a stack model used to simulate the performance of measurement structures for a patterning process, the method comprising:

obtaining, with one or more processors, a stack model used in a simulation of the performance of the measurement structures;

obtaining, with one or more processors, calibration data indicative of performance of the measurement structures in the patterning process, the calibration data being empirical measurements or results of simulations of performance of the measurement structures;

after obtaining the calibration data, with one or more processors, calibrating parameters of the stack model by, until a termination condition occurs, repeatedly:
a) simulating performance of the measurement structures based on a candidate stack model having candidate-model parameters;
b) approximating the simulated performance over a range of candidate stack models, based on evaluation of a surrogate function mapping the candidate-model parameters to a measure of fitness and/or a measure of uncertainty about fitness, wherein the fitness is indicative of a difference between the approximated simulated performance and the calibration data;
c) selecting a new candidate stack model based on the fitness and/or uncertainty about the fitness;
d) go back to a), wherein the performance is simulated based on the new candidate stack model having new candidate model parameters.
   24. The method of clause 22 or clause 23, wherein calibrating parameters of the stack model comprises calibrating a model of a patterned film stack in which the alignment marks, overlay metrology targets or other measurement structures are formed, wherein calibrating is performed using Bayesian optimization and wherein the surrogate function is fitted to simulation results.
   25. The method of any of clauses 22 to 24, wherein calibrating parameters of the stack model comprises concurrently calibrating parameters of a plurality of stack models of a plurality of measurement structures, the plurality including an alignment mark, an overlay metrology target, a critical dimension metrology target, a plurality of alignment marks, a plurality of overlay metrology targets, a plurality of critical dimension metrology targets, or a combination selected therefrom.
   26. The method of any of clauses 22 to 25, comprising:

determining that a previous stack model results in a simulation that does not correctly predict the performance of the measurement structures in the patterning processes relative to obtained empirical measurements of performance, wherein:
calibrating is performed in response to the determination, and
the calibration causes the previous stack model to change such that the simulation more closely matches the obtained empirical measurements relative to simulations based on the previous stack model.
   27. The method of any of clauses 22 to 26, wherein approximating the simulation with the surrogate function comprises approximating an aggregate measure of differences between the empirical measurements and the simulation over a range of candidate models as a Gaussian process, wherein the measure of fitness is a mean of the Gaussian process and the measure of uncertainty is a variance or standard deviation of the Gaussian process.
   28. The method of any of clauses 22 to 27, wherein approximating the simulation over a range of candidate stack models, based on a result of the simulation, with a surrogate function comprises:

obtaining a prior version of the surrogate function; and

transforming the prior version of the surrogate function into a posterior version of the surrogate function based on a data likelihood function and the results of the simulation with Bayes' rule of inference.

29. The method of any of clauses 22 to 28, wherein the simulation is configured to simulate responses of alignment marks, overlay metrology targets or other measurement structures to process variation by varying parameters of the stack model, the parameters including film thickness, etch depth, line-width, and/or line-pitch, and simulating results of the variations.
30. The method of any of clauses 22 to 29, wherein approximating the simulation over a range of candidate stack models comprises root-mean-square values of performance indicator differences between approximated simulation results based on input candidate stack models and the obtained calibration data.
31. The method of any of clauses 22 to 30, wherein the performance of measurement structures is indicative of a ratio of change in a parameter of the model to a change in a measure of alignment.
32. The method of any of clauses 22 to 31, wherein calibrating parameters of the model comprises repeatedly, in at least some iterations, training the surrogate function based on simulation results.
33. The method of any of clauses 22 to 32, wherein:

the measurement structures comprise a grating at least partially overlapping another grating in a film stack; and

more than four parameters of the stack model are concurrently calibrated with a global optimization.

34. The method of any of clauses 22 to 33, wherein at least some adjustments to the model are not based on a gradient descent of a function based on the simulation and the empirical measurements, and wherein calibration is performed without using a closed form equation expression of the simulation.
35. The method of any of clauses 22 to 34, wherein the surrogate function correlates points in a parameter space of the stack model with respective statistical distributions of outputs at the respective points.
36. The method of clause 35, comprising adjusting the surrogate function based on the result of the simulation by:

for a point in the parameter space of the stack model upon which the simulation is based:
aligning a measure of central tendency of the respective statistical distribution to the result of the simulation; and
reducing or eliminating a measure of variance of the respective statistical distribution; and

for a point in the parameter space adjacent the point upon which the simulation is based:
adjusting a measure of central tendency of the respective statistical distribution to be closer to the result of the simulation; and
reducing a measure of variance of the respective statistical distribution.
   37. The method of any of clauses 22 to 36, wherein selecting a new candidate stack model based on the measure of fitness and/or the measure of uncertainty about fitness comprises determining candidate stack model parameters by determining an extremum of an acquisition function that is based on both the measure of fitness and the measure of uncertainty about fitness.
   38. The method of clause 37, wherein:

the extremum is a global maximum;

between repetitions of the calibration, adjusting a parameter of the acquisition function to change relative effects of the measure of fitness and the measure of uncertainty about fitness to decrease an amount of effect on the acquisition function by the measure of uncertainty about fitness and increases an amount of effect on the acquisition function by the measure of fitness.

39. The method of any of clauses 22 to 38, wherein calibrating parameters of the stack model comprises calibrating parameters of statistical distributions of parameters of the stack model.
40. The method of any of clauses 22 to 39, wherein calibrating parameters of the model comprises using simulations of both alignment mark performance and overlay metrology target performance to infer a plurality of parameters of a film stack with which both alignment marks and overlay metrology targets are formed.
41. The method of any of clauses 22 to 40, comprising:

simulating performance of the measurement structures using calibrated parameters of the stack model;

causing a calibrated simulation result to be displayed to a user;

receiving, from the user, an adjustment to the measurement structures; and

patterning a plurality of substrates based on measurements of the measurement structures.

42. A system, comprising:

one or more processors; and

memory storing instructions that when executed by at least some of the processors effectuate operations comprising:
obtaining a stack model used in a simulation of performance of measurement structures used in a patterning process;
obtaining calibration data indicative of performance of the measurement structures in the patterning process, the calibration data being empirical measurements or results of simulations of performance of the measurement structures;
after obtaining the calibration data calibrating parameters of the stack model by, until a termination condition occurs, repeatedly:
   performing simulation of the performance of the measurement structures using a candidate stack model having candidate-model parameters;
   approximating the simulation over a range of candidate stack models, based on a result of the simulation, with a surrogate function, wherein the surrogate function:
      takes as an input candidate stack models having candidate-model parameters, and
      outputs a measure of fitness and/or a measure of uncertainty about fitness, wherein fitness is indicative of differences between approximated simulation results based on input candidate stack models and the obtained calibration data; and
   selecting a new candidate model based on the measures of fitness and/or measures of uncertainty about fitness; and
storing the new candidate model parameters associated with the new candidate model as calibrated parameters of the stack model in memory.

The reader should appreciate that the present application describes several inventions. Rather than separating those inventions into multiple isolated patent applications, applicant has grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, any such conflicting text in such incorporated by reference U.S. patents, U.S. patent applications, and other materials is specifically not incorporated by reference in this patent.

1. A method of calibrating parameters of a stack model used to simulate the performance of measurement structures in a patterning process, the method comprising:
obtaining a stack model used in a simulation of performance of measurement structures used in a patterning process;
obtaining calibration data indicative of performance of the measurement structures in the patterning process, the calibration data being empirical measurements or results of simulations of performance of the measurement structures;
after obtaining the calibration data, calibrating, by a processing system, parameters of the stack model by, until a termination condition occurs, repeatedly:
performing the simulation of performance of measurement structures using a candidate stack model having candidate-model parameters;
approximating the simulation over a range of candidate stack models, based on a result of the simulation, with a surrogate function, wherein the surrogate function:
takes as an input candidate stack models having candidate-model parameters, and
outputs a measure of fitness and/or a measure of uncertainty about fitness, wherein fitness is indicative of differences between approximated simulation results based on an input candidate stack model and the obtained calibration data; and
selecting a new candidate model based on the measure of fitness and/or measure of uncertainty about fitness.

2. The method of claim 1, wherein calibrating parameters of the stack model comprises calibrating a model of a patterned film stack in which the measurement structures are formed, wherein calibrating is performed using Bayesian optimization and wherein the surrogate function is fitted to simulation results.

3. The method of claim 1, wherein calibrating parameters of the stack model comprises concurrently calibrating parameters of a plurality of stack models of a plurality of measurement structures, the plurality of measurement structures including an alignment mark, an overlay metrology target, a critical dimension metrology target, a plurality of alignment marks, a plurality of overlay metrology targets, a plurality of critical dimension metrology targets, or a combination selected therefrom.

4. The method of claim 1, comprising:
determining that a previous stack model results in a simulation that does not correctly predict the performance of the measurement structures in the patterning process relative to obtained empirical measurements of performance,
wherein:
calibrating is performed in response to the determination, and
the calibration causes the previous stack model to change such that the simulation more closely matches the obtained empirical measurements relative to simulations based on the previous stack model.

5. The method of claim 1, wherein approximating the simulation with the surrogate function comprises approximating an aggregate measure of differences between the empirical measurements and the simulation over a range of candidate models as a Gaussian process, wherein the measure of fitness is a mean of the Gaussian process and the measure of uncertainty is a variance or standard deviation of the Gaussian process.

6. The method of claim 1, wherein approximating the simulation over a range of candidate stack models, based on a result of the simulation, with a surrogate function comprises:
obtaining a prior version of the surrogate function; and
transforming the prior version of the surrogate function into a posterior version of the surrogate function based on a data likelihood function and the results of the simulation with Bayes' rule of inference.

7. The method of claim 1, wherein the simulation is configured to simulate responses of measurement structures in the form of alignment marks or overlay metrology targets to process variation by varying parameters of the stack model, the parameters including film thickness, etch depth, line-width, and/or line-pitch, and simulating results of the variations.

8. The method of claim 1, wherein approximating the simulation over a range of candidate stack models comprises root-mean-square values of performance indicator differences between approximated simulation results based on input candidate stack models and the obtained calibration data.

9. The method of claim 1, wherein the performance of measurement structures is indicative of a ratio of change in a parameter of the model to a change in a measure of alignment.

10. The method of claim 1, wherein calibrating parameters of the model comprises repeatedly, in at least some iterations, training the surrogate function based on simulation results.

11. The method of claim 1, wherein:
the measurement structures comprise a grating at least partially overlapping another grating in a film stack; and
more than four parameters of the stack model are concurrently calibrated with a global optimization.

12. The method of claim 1, wherein the surrogate function correlates points in a parameter space of the stack model with respective statistical distributions of outputs at the respective points.

13. The method of claim 12, comprising adjusting the surrogate function based on the result of the simulation by:
for a point in the parameter space of the stack model upon which the simulation is based:
aligning a measure of central tendency of the respective statistical distribution to the result of the simulation; and
reducing or eliminating a measure of variance of the respective statistical distribution; and
for a point in the parameter space adjacent the point upon which the simulation is based:
adjusting a measure of central tendency of the respective statistical distribution to be closer to the result of the simulation; and
reducing a measure of variance of the respective statistical distribution.

14. The method of claim 1, wherein selecting a new candidate stack model based on the measure of fitness and/or the measure of uncertainty about fitness comprises determining candidate stack model parameters by determining an extremum of an acquisition function that is based on both the measure of fitness and the measure of uncertainty about fitness.

15. The method of claim 14, wherein:
the extremum is a global maximum;
between repetitions of the calibration, adjusting a parameter of the acquisition function to change relative effects of the measure of fitness and the measure of uncertainty about fitness to decrease an amount of effect on the acquisition function by the measure of uncertainty about fitness and increases an amount of effect on the acquisition function by the measure of fitness.

16. The method of claim 1, wherein calibrating parameters of the stack model comprises calibrating parameters of statistical distributions of parameters of the stack model.

17. The method of claim 1, wherein calibrating parameters of the model comprises using simulations of both alignment mark performance and overlay metrology target performance to infer a plurality of parameters of a film stack with which both measurement structures in the form of alignment marks and overlay metrology targets are formed.

18. The method of claim 1, comprising:
simulating performance of the measurement structures using calibrated parameters of the stack model;
causing a calibrated simulation result to be displayed to a user;
receiving, from the user, an adjustment to the measurement structures; and
patterning a plurality of substrates based on measurements of the measurement structures.

19. A system, comprising:
one or more processors; and
memory storing instructions that when executed by at least some of the processors effectuate operations comprising:
obtaining a stack model used in a simulation of performance of measurement structures used in a patterning process;
obtaining calibration data indicative of performance of the measurement structures in the patterning process, the calibration data being empirical measurements or results of simulations of performance of the measurement structures;
after obtaining the calibration data, calibrating parameters of the stack model by, until a termination condition occurs, repeatedly:
performing simulation of the performance of the measurement structures using a candidate stack model having candidate-model parameters;
approximating the simulation over a range of candidate stack models, based on a result of the simulation, with a surrogate function, wherein the surrogate function:
takes as an input candidate stack models having candidate-model parameters, and
outputs a measure of fitness and/or a measure of uncertainty about fitness, wherein fitness is indicative of differences between approximated simulation results based on input candidate stack models and the obtained calibration data; and
selecting a new candidate model based on the measures of fitness and/or measures of uncertainty about fitness; and
storing the new candidate model parameters associated with the new candidate model as calibrated parameters of the stack model in memory.

20. A method of calibrating parameters of a stack model used to simulate the performance of measurement structures for a patterning process, the method comprising:
obtaining a stack model used in a simulation of the performance of the measurement structures;
obtaining calibration data indicative of performance of the measurement structures in the patterning process, the calibration data being empirical measurements or results of simulations of performance of the measurement structures;
after obtaining the calibration data, calibrating, by a processing system, parameters of the stack model by, until a termination condition occurs, repeatedly:
a) simulating performance of the measurement structures based on a candidate stack model having candidate-model parameters;
b) approximating the simulated performance over a range of candidate stack models, based on evaluation of a surrogate function mapping the candidate-model parameters to a measure of fitness and/or a measure of uncertainty about fitness, wherein the fitness is indicative of a difference between the approximated simulated performance and the calibration data;
c) selecting a new candidate stack model based on the fitness and/or uncertainty about the fitness;
d) go back to a), wherein the performance is simulated based on the new candidate stack model having new candidate model parameters.
